(19) United States
(12) Patent Application Publication
(10) Pub. No.: US 2024/0360573 A1
(43) Pub. Date: Oct. 31, 2024

(54) CONDUCTIVE, ELECTROCHEMICALLY AND CHEMICALLY STABLE MATERIAL

(71) Applicant: Robert Bosch GmbH, Stuttgart (DE)

(72) Inventors: Mordechai KORNBLUTH, Brighton, MA (US); Daniil KITCHAEV, Brookline, MA (US); Charles TUFFILE, Swansea, MA (US); Juergen HACKENBERG, Sachsenheim (DE); Tobias SCHULER, Baden Württemberg (DE)

(21) Appl. No.: 18/308,129

(22) Filed: Apr. 27, 2023

(51) Int. Cl. C25B 11/069; C01G 53/00; C25B 9/23; C25B 11/032; C25B 11/036

(52) U.S. Cl. CPC C25B 11/069; C01G 53/70; C25B 9/23; C25B 11/032; C25B 11/036; C01P 2002/50; C01P 2006/40

(57) ABSTRACT

An alkaline electrochemical cell component includes a bulk portion and a surface portion including a conductive, electrochemically and chemically stable material having one or more compounds of formula (I): La(Ni₁₋ₓCuₓ)O₃ (I), where 0<=x<=1, the electrochemical cell having a pH>7.

### TECHNICAL FIELD

The present disclosure relates to an electrically conductive material which is also electrochemically and chemically stable, the material being configured for use in alkaline and high voltage environments of electrochemical cells. The disclosure relates to methods of producing and using the material in various applications.

### BACKGROUND

Metals have been a widely used material for thousands of years. Various methods have been developed to preserve metals and prevent their corrosion or disintegration into oxides, hydroxides, sulfates, and other salts. Metals in some industrial applications are especially susceptible to corrosion due to aggressive operating environments. Non-limiting examples may be metal components of electrochemical cells such as a bipolar plate (BPP). In addition, certain components such as the BPP are required to not only be sufficiently chemically inert to resist degradation in the highly corrosive environment of the electrochemical cells, but also be electrically conducting. Finding a material that meets both the requirements has been a challenge.

### SUMMARY

According to one embodiment, an alkaline electrochemical cell component is disclosed. The component includes a bulk portion and a surface portion including a conductive, electrochemically and chemically stable material having one or more compounds of formula (I):

La(Ni₁₋ₓCuₓ)O₃ (I),

where 0<=x<=1.

The electrochemical cell may have a pH>7. The component may be a bipolar plate, gas diffusion layer, or porous transport layer. The one or more surface compounds may include LaNiO₃, LaCuO₃, or both. The component may further include one or more compounds of formula (III), different from the one or more compounds of formula (I):

AₓB_{y}O_{z} (III),
where
A is La or an alkaline earth metal,
B is a transition or post-transition metal,
x is any number between 0 and 7,
y is any number between 0.1 and 22, and
z is any number between 1 and 40.

The surface portion may include one or more portions free of the material of formula (I). The bulk portion may include steel. The electrochemical cell may be an alkaline exchange membrane electrolyzer. At least some of the one or more surface compounds of formula (I) may include one or more oxygen vacancies.

In another embodiment, an alkaline electrochemical cell is disclosed. The cell includes one or more surfaces having a conductive, electrochemically and chemically stable material having one or more compounds of formula (I):

La(Ni₁₋ₓCuₓ)O₃ (I),

where 0<=x<=1,

The electrochemical cell may have a pH>7. The cell may be an alkaline exchange membrane electrolyzer. The one or more surface compounds may include LaNiO₃, LaCuO₃, or both. The conductive, electrochemically and chemically stable material may further include one or more compounds of formula (III), different from the one or more compounds of formula (I):

AₓB_{y}O_{z}, (III),
where
A is La or an alkaline earth metal,
B is a transition or post-transition metal,
x is any number between 0 and 7,
y is any number between 0.1 and 22, and
z is any number between 1 and 40.

At least some of the one or more surface compounds of formula (I) may include one or more oxygen vacancies. The conductive, electrochemically and chemically stable material may have electrical conductivity of at least 10⁻¹ S/cm.

In yet another embodiment, a conductive, electrochemically and chemically stable material is disclosed. The material includes a first oxide having a formula (I):

La(Ni₁₋ₓCuₓ)O₃ (I),

where 0<=x<=1; and

The material may also include a second oxide having formula (III), different from the one or more compounds of formula (I):

AₓB_{y}O_{z} (III),
where
A is La or an alkaline earth metal,
B is a transition or post-transition metal,
x is any number between 0 and 7,
y is any number between 0.1 and 22, and
z is any number between 1 and 40.

The material may be an alkaline corrosion resistant material having electrical conductivity of at least 10⁻¹ S/cm. The first oxide may include oxygen vacancies. The first oxide may include LaNiO₃, LaCuO₃, or both. B may include Cr, Zr, Al, or Ti. The second oxide may include magnesium. The second oxide may include MgNiO₃. The material of claim 14 may further include a third oxide having formula (V):

A_{0.1}Fe_{1.9}O₃ (V),

where A is La, B, C, Be, Al, Rh, Ru, Pd, or Cr.

### BRIEF DESCRIPTION OF THE DRAWINGS

FIG. 1 depicts a schematic composition of a proton-exchange-membrane fuel cell including a bipolar plate according to one or more embodiments;

FIG. 2 shows a schematic view of an anion-exchange-membrane (AEM) electrolyzer;

FIG. 3 shows a non-limiting example of an electrochemical cell bipolar plate (BPP);

FIG. 4 is a non-limiting example algorithm for stability screening of decomposition products according to one or more embodiments disclosed herein;

FIGS. 5A, 5B are computed Pourbaix diagrams for iron (Fe) and an empirical interpretation of the Pourbaix diagram of FIG. 5A, respectively;

FIG. 6A is a Pourbaix diagram for lanthanum nickel oxide (LaNiO₃);

FIG. 6B is a Pourbaix diagram for lanthanum copper oxide (LaCuO₃);

FIG. 7 shows a plot of stability against CO₃/K and OH− in relation to material cost for Fe-based materials disclosed herein;

FIG. 8 shows a plot of alkaline stability in relation to material cost for oxide materials disclosed herein;

FIG. 9 shows a search scatterplot for binary and ternary oxides disclosed herein;

FIG. 10 is a decision tree analysis for binary and ternary oxides according to the search criteria disclosed herein;

FIG. 11 shows a search scatterplot for inorganic compounds disclosed herein;

FIG. 12 is a decision tree analysis for inorganic compounds according to the search criteria disclosed herein;

FIG. 13 shows a search scatterplot for steel materials disclosed herein; and

FIG. 14 is a decision tree analysis for steel materials according to the search criteria disclosed herein.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within ±5% of the value. As one example, the phrase “about 100” denotes a range of 100±5, i.e. the range from 95 to 105. Generally, when the term “about” is used, it can be expected that similar results or effects according to the disclosure can be obtained within a range of ±5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-20.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Metals present a widely used group of materials in numerous industries including automotive, construction, home appliances, tools, pipes, railroad tracks, coinage, etc. Metals have been utilized for thousands of years and have remained a material of choice for certain applications due to their properties such as strength and resilience. Yet, corrosion of metals is a major source of degradation and lifetime limitations for a number of applications using metals.

Corrosion is a natural process which converts a refined metal to a more chemically-stable form such as dissolved metal ions or metal's oxide(s), hydroxide(s), chloride(s), sulfide(s), and/or other salts. The conversion presents a gradual destruction of the metal material caused by electrochemical oxidation of the metal in a reaction with an oxidant such as oxygen or other oxidizing agents. Corrosion may be invoked by exposure of the metal substrate to moisture in the air, to a solution with a relatively low or high pH, various chemical substances such as acids, microbes, elevated temperatures, strong oxidants, and/or other factors. Corrosion typically starts at the interface between a bulk metal material (e.g., steel) and a solution (e.g., ions dissolved in water or water surface layer which react to degrade the bulk material).

Many efforts have been made to prevent or slow down corrosion of metals. For instance, various types of coatings have been developed. Example coatings include applied coatings such as paint, plating, enamel; reactive coatings including corrosion inhibitors such as chromates, phosphates, conducting polymers, surfactant-like chemicals designed to suppress electrochemical reactions between the environment and the metal substrate, anodized surfaces, or biofilm coatings. Other methods of corrosion prevention include controlled permeability framework, cathodic protection, or anodic protection.

Yet the most popular solution to the corrosion problem remains to be fortification of the vulnerable metal surface with a coating. Most corrosion-resistant surfaces thus include one or more chemically inert coatings or protective layers that can slow down and/or at least partially prevent corrosion from occurring. Still, it has remained a challenge to find a material with substantial anticorrosion properties which would be also friendly to the environment, economical, and having superb performance characteristics.

Moreover, some applications are highly susceptible to corrosion due to their environmental factors. A non-limiting example of such application are electrochemical cells such as fuel cells and electrolyzers. A proton-exchange-membrane fuel cell (PEMFC) represents an environmental-friendly alternative to internal combustion engines for a variety of vehicles such as cars and buses. The PEMFC typically features a relatively high efficiency and power density. A very attractive feature of the PEMFC engine are no carbon emissions, provided that the hydrogen fuel has been gained in an environmentally-friendly manner. Besides being a green engine, the PEMFC may be used in other applications such as stationary and portable power sources.

The PEMFC's own operating environment lends itself to corrosion for a variety of reasons. For example, relatively large voltage swings exist between startups and shutdowns of the PEMFC, PEMFC has a strongly acidic environment, fluorine ions are released from the polymer membrane during operation of the PEMFC, both H₂ and O₂ exist at the anode during the startup and shutdown which causes high cathodic potential yielding cathodic corrosion, fuel crossover of hydrogen or oxygen from the anode to cathode or vice versa, etc. The PEMFC thus requires durable components capable of withstanding the above-mentioned conditions.

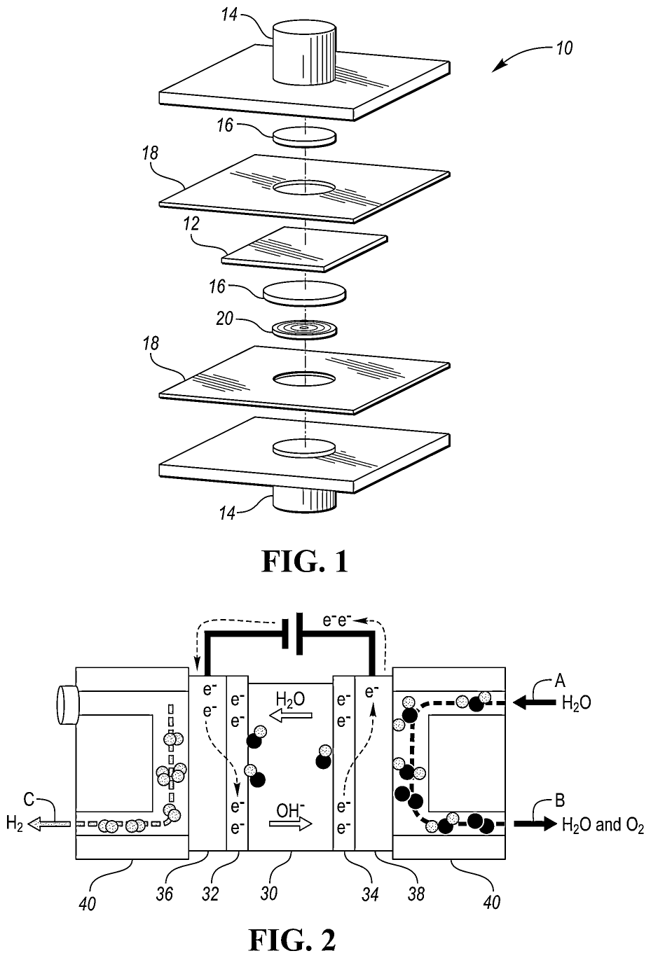

A non-limiting example of a PEMFC is depicted in FIG. 1. A core component of the PEMFC 10 that helps produce the electrochemical reaction needed to separate electrons is the Membrane Electrode Assembly (MEA) 12. The MEA 12 includes subcomponents such as electrodes, catalysts, and polymer electrolyte membranes. Besides MEA 12, the PEMFC 10 typically includes other components such as current collectors 14, gas diffusion layer(s) 16, gaskets 18, and bipolar plate(s) 20.

In parallel opposite to a PEMFC is a PEM electrolyzer. Whereas the PEMFC consumes hydrogen and oxygen to create electricity and water, a PEM electrolyzer is an electrochemical device designed to convert electricity and water into hydrogen and oxygen. A PEMFC and a PEM electrolyzer may be used together to store energy via hydrogen. The PEM electrolyzer utilizes electrolysis for hydrogen production. The PEM electrolyzer may be utilized in applications including industrial, residential, and military applications and technologies focused on energy storage such as electrical grid stabilization from dynamic electrical sources including wind turbines, solar cells, or localized hydrogen production for industrial and other uses.

Typical electrolyzers apply a voltage to water to separate the water into oxygen and hydrogen. Some electrolyzers use an anion exchange membrane (AEM, sometimes also called an alkaline exchange membrane) to move hydroxide ions between the cathode and anode. At the cathode, the water is split to form H₂ gas and OH⁻ ions. OH⁻ ions then move to the anode where they react to form O₂, as shown in a schematic of an AEM electrolyzer in FIG. 2.

In FIG. 2, the AEM 30 is shown adjacent the HER catalyst 32 and the OER catalyst 34. The catalyst layers 32, 34 are located adjacent the gas diffusion layer (GDL) and/or porous transport layer (PTL) on the cathode 36 and anode 38, respectively. The flow fields and current collectors are shown as 40. In the AEM electrolyzer 30, water enters the unit at A, at B water and 02 exit the system. At C, produced H₂ exits. The movement of water and OH− through the system is also shown in FIG. 2.

The electrolysis in an AEM electrolyzer can be illustrated by reactions (1), (2), and (3):

Anode (OER): 2OH⁻−2e⁻=H₂O+½O₂↑ E₀=0.401 V (1)

Cathode (HER): 2H₂O+2e⁻=2OH⁻+H₂↑ E₀=−0.8277 V (2)

Full: 2H₂O=O₂↑+2H₂↑ E₀=1.23 V (3)

Due to the alkaline environment, a longstanding problem of AEM electrolyzers is stability of its components. Indeed, a combination of alkaline environment and high voltage at the anode, various components of the AEM electrolyzer may corrode or react with the environment.

In comparison to other types of electrochemical cells, the AEM electrolyzer environment faces different challenges. For example, while PEM electrolyzers include high voltage, they feature relatively low pH and thus acidic instead of an alkaline environment. Alkaline fuel cells, on the other hand, feature an alkaline environment with high pH, but low voltage. The AEM electrolyzer environment is thus unique in its setting of both alkaline pH and high voltage.

A particular component which may suffer from the high voltage and alkalinity are the current collectors or bipolar plate (BPP), as well as the transport layers such as the gas diffusion layer (GDL) or the porous transport layer (PTL). These components may be exposed to the high-voltage alkaline conditions at the anode and nonetheless be required to conduct electrons between the anode catalyst and the power source. Typical conditions of the AEM electrolyzer may be about 0.6 V vs. the standard hydrogen electrode (SHE) with excursions to +/−0.5 V and pH 13+/−2, corresponding to an electrolyte of approximately 0.2M KOH. The total voltage across the cell may be as high as 2.5 V.

BPP, GDL, and PTL are also high-volume and relatively expensive components and a frequent reason for degradation of electrochemical cells. For example, BPPs may constitute about 60-80% of a PEMFC stack weight, about 50% of the stack volume, and about 25-45% of the stack cost. To keep the cost of BPPs in the electrochemical cells low, the BPP is typically made from metal, for example steel such as stainless steel (18% Cr 8% Ni). Alternative materials such as aluminum, nickel, carbon or titanium have been used. Yet, all of these materials may still degrade in alkaline conditions.

In addition, pure nickel (Ni) and alloys with a relatively high Ni content, as well as, Ni-based coatings have been used to protect the BPPs, GDLs, and PTLs of AEM electrolyzers. Ni is stabilized under alkaline conditions because oxides form on the surface. Therefore, nickel is not dissolved, but this unfortunately leads to an increase in the contact resistance between the components due to the oxide. Ni coatings, additionally, have disadvantages such as relatively high cost and environmental concerns.

Additionally, in electrochemical cells, the BPP, GDL, and PTL present yet another material challenge as they are also required to be electrically conducting. Therefore, the chosen material needs to be electrically conducting but chemically and electrochemically inert to reactions with ions present in the electrochemical cell environment.

Typically, the BPP, GDL, or PTL metal surface contains a coating such as graphite-like coating or protective oxide or nitride coatings to increase corrosion resistance. Alternative coatings include Ti alloy, doped TiOₓ, Cr₂O₃, TiO₂, TiN, CrN, or ZrN. Yet, in an aggressively corrosive environment of the electrochemical cells, where coatings are more likely to degrade faster than in other applications, a need remains for a coating or material that would be economically feasible, corrosion resistant, chemically protective, electrochemically resistant, electrically conductive, and capable of forming a coherent interface (i.e., a small interfacial contact resistance) with the metal substrates at the same time.

In one or more embodiments, an electrochemical cell component is disclosed herein. The cell may be a fuel cell or an electrolyzer. The electrolyzer may be an AEM electrolyzer. The component may be a BPP, a GDL, or a PTL. The cell component may include a substrate having a material disclosed herein. The material disclosed herein solves one or more problems described above and/or provides the benefits identified herein.

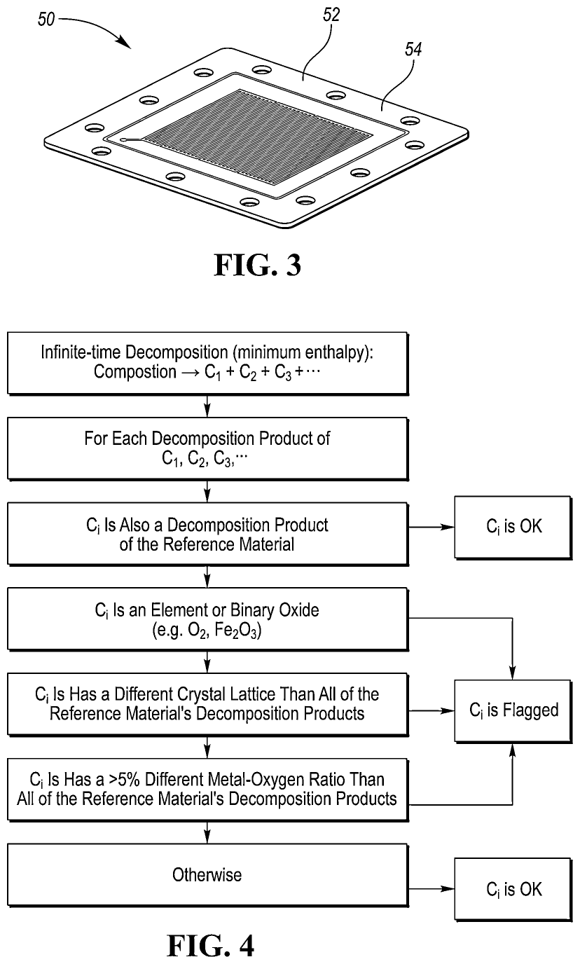

A non-limiting example of a BPP 50 is shown in FIG. 3. The BPP 50 represents a non-limiting example of a substrate having a solid body or bulk portion 52 and a surface portion 54. The bulk portion 52 may be formed from a metal such as steel, stainless steel, aluminum, copper, an alloy of two or more metals, the like, or a combination thereof. Alternatively, the bulk portion 52 may be formed from a composite material such as carbon-carbon composite, or carbon-polymer composite. Alternatively still, the bulk portion 52 may be made from graphite or another carbon allotrope. In another embodiment, the bulk portion 52 may also include the disclosed material.

The surface portion 54 may include the anticorrosive, chemically inert, electrically conductive, and thermodynamically stable material disclosed herein. The entire area of the surface portion 54 may include the material. Alternatively, the surface portion 54 may include one or more subportions which are free from the material. In an example embodiment, the entire surface portion 54 may include the material such that the entire BPP 50 is protected against corrosion. In other applications such as non-BPP applications, only a small portion of the surface portion 54 may include the material such as less than about ½, ¼, ⅛, 1/16, 1/32, 1/50, or the like of the surface portion may include the material. For example, one or more areas of the BPP may include a greater amount of the disclosed material than at least one another portion of the BPP to reinforce high corrosion area(s).

The surface portion 54, the bulk portion 52, or both may include one or more layers of the disclosed material. The material thickness on the surface portion 54 may be adjusted according to the needs of a specific application. A non-limiting example of the material layer thickness may be about 0.1 to 0.8 μm, 0.2 to 0.6 μm, or 0.3 to 0.5 μm. Alternatively, the material may be layered to form a relatively thick deposit with dimensions of more than 1 μm on the surface portion 54 such as about or at least about 1.25, 1.5, 1.75, 2.0, 2.25, 2.5, 2.75, 3.0, 3.25, 3.5, 3.75, 4.0, 4.25, 4.5, 4.75, 5.0, 6, 7, 8, 9, 10, 15, 20, 25, 30, 35, 40, 45, 50, 55, 60, 65, 70, 75, 80, 85, 90, 95, 100, 110, 120, 130 140, 150, 200, 250 μm or about 1.25, 1.5, 1.75, 2.0, 2.25, 2.5, 2.75, 3.0, 3.25, 3.5, 3.75, 4.0, 4.25, 4.5, 4.75, 5.0, 6, 7, 8, 9, 10, 15, 20, 25, 30, 35, 40, 45, 50, 55, 60, 65, 70, 75, 80, 85, 90, 95, 100, 110, 120, 130 140, 150, 200, 250, 300, 350, 400, 450, or 500 nm. The material may form one or more layers or a plurality of layers on the bulk portion 52. The material may form 1, 2, 3, 4, 5, 6, 7, 8, 9, 10, or more layers on the bulk portion 54. Each layer may have a thickness within the nanoscale or microscale recited herein with respect to the thickness of the surface portion 54.

The disclosed material may be used in applications requiring corrosion resistance, electrochemical stability, and good electrical conductivity. An example environment may be an AEM electrolyzer environment, an environment or an AEM electrolyzer anode, an environment with pH>7, a high voltage environment with pH>7, or the like. For example, the disclosed material may be used as a BPP coating, in a BPP bulk portion, in a BPP surface portion, or a combination thereof. The material may be also applied to other relevant components of the cell, stack, or system which are exposed to an alkaline environment. This may include current collectors, porous transport layers, gas diffusion layers, flow distributors, pressure valves, etc. The material may be further used as a conductive catalyst layer support, i.e. part of the junction between the catalyst and the rest of the electric circuit. This may be implemented as metal or oxide nanoparticles, core-shell catalysts (i.e. part of the core or shell), or a binder additive to the catalyst layer.

A cell component may include more than 1 wt. % of the material disclosed herein, based on the total weight of the component. The material may be electrically conductive, such as having a conductivity of at least 10⁻¹ to 10⁻³ S/cm. The material may thus be electrically conductive, electrochemically stable, and chemically stable at the same time. Stability relates to the material not succumbing to undesirable corrosive reactions which result in deterioration of the material and formation of undesirable decomposition products. To further modify or increase electrical conductivity, oxygen vacancies may be introduced into the material. The material may include about 1-30, 2-25, or 5-20% of oxygen vacancies compared to the nominal stoichiometry. The material may thus be non-stoichiometric on purpose. The oxygen vacancies may render the material non-stoichiometric or deviating from stoichiometry such that the elemental composition of the material may not be represented by a ratio of well-defined natural numbers.

Alternatively, the disclosed material may be used as an anticorrosive coating in automotive parts, aerospace parts, oil and gas plants, or large-scale manufacturing. In an alternative embodiment, the disclosed material may be used as a catalyst support material, for example for electrochemical cell applications or other catalytic applications.

The material may be resistant to the following reactions listed in Table 1:

TABLE 1
Material resistance to undesirable reactions
occurring in the AEM electrolyzer environment

| Reaction | Description |
|---|---|
| M + OₓH_{y} + ze⁻ → MOₐH_{b} | Electrochemical alkaline corrosion |
| M + OH → MOH or MH + 0.5O₂ or | Chemical alkaline reactivity |
| MO_{0.5} + 0.5H₂O | |
| M + K → MK | Chemical reactivity with the |
| | potassium in the electrolyte |
| M + CO₃ → MCO₃ or MO + CO₂ | Chemical reactivity with the |
| | carbonate in the electrolyte |
| — | Electrical resistivity |

The disclosed material may have a perovskite structure, perovskite-like structure, be non-crystalline, or have amorphous structure. The material may include, compromise, consist of, or essentially consist of one or more compositions or compounds having a formula (I):

La(Ni₁₋ₓCuₓ)O₃ (I),

where 0<=x<=1.

In formula (I), 0<=x<=1 or 0<x<1. x may be any number between 0 and 1. x may be 0, 0.1, 0.2, 0.3, 0.4, 0.5, 0.6, 0.7, 0.8, 0.9, or 1. The material may include a cuprate, nickelate, or both. Non-limiting example compounds of formula (I) may include lanthanum nickel oxide (LaNiO₃), lanthanum copper oxide (LaCuO₃), or a combination thereof.

The disclosed material may include, compromise, consist of, or essentially consist of one or more compositions or compounds having a formula (II):

AₓB_{y}O_{z}, (II),
where
A is La or Mg;
B is a transition metal or a post-transition metal,
x is any number between 0 and 2,
y is any number between 0.1 and 2, and
z is any number between 1 and 6.

In formula (II), B may be Al, Cr, Cu, Ni, Zr, or Ti. B may be Al, Cr, Zr, or Ti.

In formula (II), 0≤x≤2 or 0<x<2. x may be 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0.

In formula (II), 0≤y≤2 or 0<y<2. y may be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0.

In formula (II), 1≤z≤6 or 1<z<6. z may be 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or 6.0.

The material may include an aluminate, chromate, cuprate, nickelate, zirconate, or titanate. Non-limiting example compounds of formula (II) may include LaNiO₃, LaCuO₃, and MgNiO₃.

The disclosed material may include, compromise, consist of, or essentially consist of one or more compositions or compounds having a formula (III):

AₓB_{y}O_{z} (III),
where
A is La or an alkaline earth metal,
B is a transition or post-transition metal,
x is any number between 0 and 7,
y is any number between 0.1 and 22, and
z is any number between 1 and 40.

In formula (III), A may be La or any alkaline earth metal including Be, Mg, Ca, or Sr. A may be Mg. In formula (III), B may be a transition metal including Cr, Cu, Ni, Zr, or Ti or a post-transition metal including Al. B may be Cr, Zr, or Al. B may be Cr, Zr, Al, or Ti.

In formula (III), 0≤x≤7 or 1≤x≤7. x may be 0, 1, 2, 3, 4, 5, 6, or 7. In formula (V), 0.1≤y≤22 or 2≤y≤22. y may be 0.1, 1, 2, 3, 4, 5, 6, 7, 8, 9, 10, 11, 12, 13, 14, 15, 16, 17, 18, 19, 20, 21, or 22. In formula (III), 1≤z≤40 or 4≤z≤40. z may be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

Non-limiting example compositions of formula (III) may include LaNiO₃, LaCuO₃, MgNiO₃, MgCr₂O₄, MgAl₂O₄, Mg₇Al₂₂O₄₀, MgZr₄O₉, Mg₂Cr₂O₅, Ca₃Zr₁₇O₃₇, Mg₃Al₁₄O₂₄, BeAl₆O₁₀, Sr₂Zr₇O₁₆, or a combination thereof.

The disclosed material may include, compromise, consist of, or essentially consist of one or more compositions or compounds having a formula (IV):

Fe_{0.9}A_{0.1} (IV),
where
A is a halogen, precious metal, O, or N.

In formula (IV), A may be a non-metal such as a halogen including Cl, Br; a precious metal such as Pt, Ir, Au, Pd, Os; or a non-metal including O, or N.

Non-limiting example compositions of formula (IV) may include Fe_{0.9}N_{0.1}, Fe_{0.9}Cl_{0.1}, Fe_{0.9}Br_{0.1}, Fe_{0.9}Pt_{0.1}, Fe_{0.9}Ir_{0.1}, Fe_{0.9}Au_{0.1}, Fe_{0.9}Os_{0.1}, Fe_{0.9}Pd_{0.1}, or a combination thereof.

The disclosed material may include, compromise, consist of, or essentially consist of one or more compositions or compounds having a formula (V):

A_{0.1}Fe_{1.9}O₃ (V),
where
A is La, B, C, Be, Al, Rh, Ru, Pd, or Cr.

Non-limiting example compositions of formula (V) may include La_{0.1}Fe_{1.9}O₃, B_{0.1}Fe_{1.9}O₃, C_{0.1}Fe_{1.9}O₃, Be_{0.1}Fe_{1.9}O₃, Al_{0.1}Fe_{1.9}O₃, Rh_{0.1}Fe_{1.9}O₃, Ru_{0.1}Fe_{1.9}O₃, or a combination thereof.

A method of preparing the material named herein is disclosed. The material may be prepared by plasma coating, powder coating, sputtering, vapor deposition, solution processing, electroplating, or another method. The material may be annealed at elevated temperatures of about above 100° C. to reduce the number of defects in the material. Alternatively, if oxygen vacancies are to be introduced and maintained in the material to increase conductivity, annealing may be avoided and sintering may be used instead because annealing may compromise the oxygen vacancies.

A method of using the material is disclosed herein. The method may include applying the material to one or more portions of a component of an electrochemical cell such as an alkaline environment electrolyzer. The component may include components disclosed herein such as BPP, catalyst layer, gas diffusion layer, porous transport layer, flow distributors, pressure valves, and/or the like.

### Experimental Section

In a vast chemical search space, it is nonobvious where to begin to search for materials that optimize a particular use-case, in this case an alkaline and high voltage environment of an AEM electrolyzer. Density Functional Theory (DFT) was used to solve a system of electronic interactions for the ground-state energy of a material. Several such databases are available, allowing a screening of large classes of materials.

The databases were used for various types of screenings:

Total energy of a computed structure (typically in eV/atom or eV) describes the computed energy of a structure; the differences between structures correspond to a reaction energy between those structures. For example, the reaction A→B has a reaction energy E_{B}−E_{A} (where the energies might be written in kJ/mol).

Convex-hull decomposition—the convex hull of all stable compositions may be constructed such that each chemical composition C has a minimum combination of stable states, C→A+B, where the stoichiometric formula of C is equal to the sum of A and B, and there is no other A′+B′ that has a lower energy. Then A+B is the convex-hull decomposition products of C. If the energy of C is known, then the hull energy or decomposition energy (typically eV/atom or eV) is Eₕ=E_{C}−E_{A}−E_{B} and is always a nonnegative number. It may be reported as the reaction energy Eᵣₓₙ=E_{A}+E_{B}−E_{C} and is always a nonpositive number.

Chemical potential (typically in eV/atom or eV) describes the energy of an element whose stoichiometry is not balanced during a reaction. Physically it may be used of oxygen or hydrogen, corresponding to an oxidative or reductive environment. It may also be used as a proxy for temperature because high temperatures may accelerate oxidation.

The concepts described herein were used to explore various classes of materials:
(a) Known materials whose DFT structure can be computed; typically single-crystal or gas-phase molecules; and
(b) Compositional formulas even if the atomic structure is not known as long as related structures are available in a database. This may include adjusting compositional ratios, such as excess oxygen or oxygen vacancies, and/or dopants and substitutions.

Based on the above, the following properties of materials were identified:
(A) Stability at a fixed temperature—this can be given by the hull energy; if it is less than the temperature (times the Boltzmann constant k_{B}), then it is stable. Alternatively, it can be computed by the oxygen chemical potential, which can be benchmarked to temperature at a known scale.
(B) Filtering by atom size, oxidation state, metal-oxygen ratio, crystal structure, spacegroup, elements, etc.
(C) Elemental material cost, per mol or per kg.
(D) Compositional stability, which may be defined such that a composition C has no decomposition products that are “red-flag” products. Instead of setting the criterion that there are no decomposition products—because many materials are commonly used that have a nonzero decomposition energy—decomposition products may be evaluated based on a reference material. An example algorithm used to screen decomposition products for the materials disclosed herein is shown in FIG. 4. The total fractional weight of flagged products Cᵢ is summed and used as a metric for instability.
(E) Reactivity screening, which is the likelihood of a reactivity between the composition C and a reactant R. Using the convex-hull methodology, the reactivity may be computed by examining (1) the decomposition products of a composition C+x R and (2) the relative decomposition energy of ε(x)=E(C+x R)−E(C)−x E(R) (a nonpositive number). The most stable reaction is the one that has the minimum F, while the dilute limit is the lowest value of x that has a nonzero P.

Using this approach, the reactivity may be benchmarked to some known material C′ using the following two quantities:
(1) At which molar fraction x does the reaction occur? A higher reactivity is associated with a higher value of x, i.e. more of the reaction occurs per molar unit of C (or C′). A typical metric is: RR_{stoich}=x_{C}/x_{C′}, where C′ is the reference material and RR stands for the relative reactivity.
(2) What is the relative decomposition energy ε? A higher reactivity is associated with a lower value of ε (higher absolute value), i.e. the reaction is more energetically favorable. A typical metric is: RRₑₙ=ε_{C}/ε_{C′}, where C′ is the reference material. It can also be: RRₑₙ=(ε_{C′}−ε_{C})/k_{B}T, where k_{B} is the Boltzmann constant and T is the absolute temperature.

Yet, unlike in purely chemical analyses, electrochemical reactivity requires a modified treatment because electrochemical reactions involve electrons as reagents or products and need to be accounted for in the reaction energy analysis. Hence, Pourbaix analysis and Pourbaix diagram was used to evaluate electrochemical stability of identified materials.

For an electrochemical reaction xA+ye⁻→zB taking place at a voltage V, the reaction energy is given by Eᵣₓₙ=zE_{B}−(xE_{A}+yV), where the reaction energy is measured in electronvolts (eV). Voltage is conventionally defined with respect to the standard hydrogen electrode (SHE) which corresponds to the voltage at which hydrogen gas at 1 atm of pressure is in equilibrium with H⁺ ions in an aqueous solution with pH=0.

Electrochemical stability was thus evaluated by finding the minimum energy reaction between elements A, B, and an arbitrary number of electrons at a specified voltage V. A specific example of this analysis referred to as Pourbaix analysis evaluates reactions involving one or two elements A and B, as well as hydrogen (H) and oxygen (O), where the ratio of elements A and B is fixed, but H, O, and electrons are allowed to vary arbitrarily.

The electrons are set to have a target voltage V. H atoms are set to have an energy dictated by the pH of the system E_{H}=E_{H0}−2.3 kT pH, where E_{H0} is a reference energy corresponding to pH=0, k is the Boltzmann constant, and T is the temperature. O atoms have an energy defined by the formation energy of water: E_{O}=E_{H2O}−2E_{H}, where E_{H2O} is a known tabulated constant. Thus, Pourbaix analysis involves identifying the product C which minimizes the energy of the reaction aA+bB+xe⁻+yO+zH→C, where the energy of the reaction is defined as Eᵣₓₙ=E_{C}−(aE_{A}+bE_{B}+xV+yE_{H2O}−(2+z)[E_{H0}−2.3 kT pH]) for a given a, b, V, and pH. This problem was solved by considering all combinations of all possible compounds and molecules involving elements A, B, O, and H, where the energies of the compounds and molecules were obtained from a combination of first-principles calculations and tabulated quantities, such as the Pourbaix Atlas, where the concentration of all dissolved ions is typically assumed to be 10⁻⁶M.

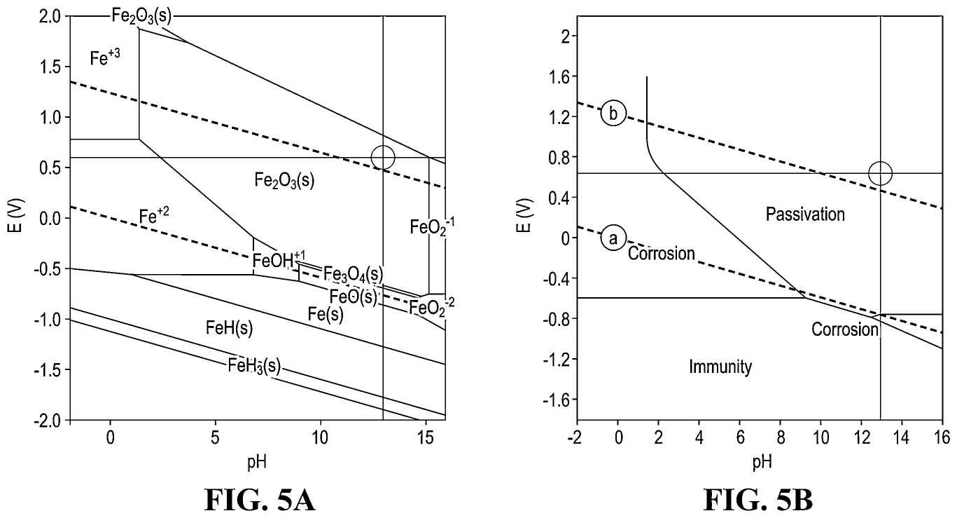

The solutions of the Pourbaix analysis for voltage and pH values of practical interest were plotted in Pourbaix diagrams. These plots show ranges of pH and voltage, where specific compounds or combinations of compounds are stable. A typical Pourbaix diagram for iron (Fe) is shown in FIGS. 5A and 5B. FIG. 5A is a computed Pourbaix diagram for Fe. FIG. 5B is an empirical interpretation of the Pourbaix diagram of FIG. 5A to evaluate electrochemical stability. In FIG. 5A, it can be seen that Fe forms Fe₂O₃ at the conditions of interest (pH=13, V˜0.6), shown with the horizontal and vertical lines and circular target, where the lines meet. Because Fe₂O₃ is a solid, this region is termed as “passivating” as shown in FIG. 5B because the predicted reaction at these conditions does not involve a soluble ion. Under more acidic conditions, the favored reaction product is Fe²⁺, which is an aqueous ion. The region where Fe²⁺ forms is termed a “corrosion” region because the electrochemical reaction involves dissolution and thus corresponds to the loss of the solid iron material.

In the Pourbaix diagrams, black lines show boundaries of where the material is stable. Decomposition products are marked; some of the products relate to corrosion processes deemed to damage the material. The dashed lines represent the water stability window.

Based on the above, several materials searches were conducted. The aim was to identify materials which are electrochemically stable at the conditions expected in an AEM electrolyzer anode, that is pH˜13 and V˜0.6+/−0.5 vs. the standard hydrogen electrode (SHE). A material was defined as electrochemically stable if it is the favored product identified by Pourbaix analysis at the likely target voltage (0.6V) and forms a minimal amount of soluble ions over the entire voltage range expected during AEM electrolyzer lifetime (0.1-1.1V vs. SHE).

Additionally, materials that are intrinsically electronically conductive were targeted in the searches. While electronic conductivity may be induced in otherwise insulating materials by postprocessing and additives, these steps increase the cost of the end product, which is not desirable. Thus, to minimize cost, the searches were focused on materials which have a predicted band gap below 0.1 eV across all available structural forms, where the band gap was obtained from standard density functional theory methods.

### I. Binary and Ternary Oxides Search Based on Electrochemical Stability

The oxide materials were screened according to the methods and criteria described above. Two ternary oxide compounds emerged as electrochemically stable and having high intrinsic electronic conductivity. The oxides include:
(a) LaNiO₃ (LNO), which is a rare earth nickelate with high Ni³⁺ oxidation state. LNO is a highly metallic strongly correlated oxide with antiferromagnetic correlations. LNO has a cubic, perovskite structure; and
(b) LaCuO₃, which is a cuprate perovskite oxide.

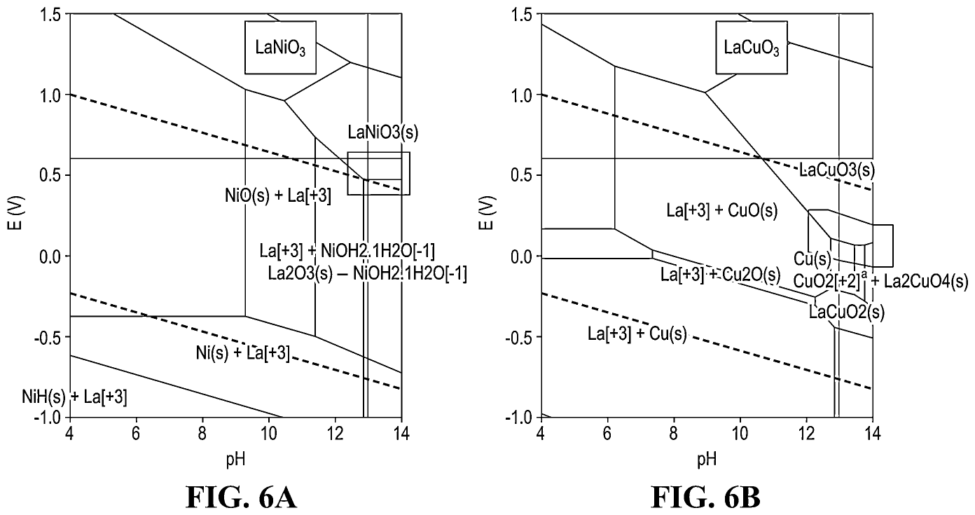

The computed Pourbaix diagrams of the two compositions are shown in FIGS. 6A and 6B, respectively. At the target conditions marked in the diagrams, both compounds are stable. At lower voltages, a number of soluble products are thermodynamically possible, but these reactions are assumed to be kinetically limited because in all cases only one part of the compound is soluble, while the remainder forms a stable solid. As can be observed from the FIGS. 6A, 6B, LNO and LaCuO₃ are stable under conditions representative of an AEM electrolyzer anode, shown at pH=13 and V=0.6. As can be also observed, the stability extends to pH as low as 9 for both materials.

Bandgap calculation of both materials was conducted, indicating that they are likely to have high intrinsic electronic conductivity.

Following the mathematical structure of the Pourbaix analysis, it was assessed that any combined material La(Ni₁₋ₓCuₓ)O₃ for 0<=x<=1 is also electrochemically stable with respect to the formation of soluble ions. Thus, it was concluded that the family of compositions La(Ni₁₋ₓCuₓ)O₃ for 0<=x<=1 is suitable as a surface layer or coating material for an AEM electrolyzer anode bipolar plate or other components disclosed herein.

### II. Steel Elemental Enhancement Search Based on Chemical Reactivity

The above-described search methodology was used to identify elements suitable for steel enhancement in the conditions representative of an AEM electrolyzer anode (pH=13 and V=0.6). The search was performed with a focus on elements that may be added to Fe and Fe₂O₃, as representative of a generic steel, that are stable to chemical reactivity against OH, CO₃, and K. For example, OH stability reveals that Ce dopants are not suitable because they form a ceria oxide easily, whereas Pt is much harder to oxidize. The search results are shown below in Table 2 for OH− as the reactant and Table 3 for K and CO₃ as reactants. The most suitable materials are bolded and underlined.

TABLE 2
OH reactivity

| | | | | Most stable |
|---|---|---|---|---|
| | | | Most stable | reaction |
| | Material + | | reactant | energy |
| Reactant | dopant | Most stable reaction | ratio [wt.] | [eV/at] |
| OH⁻ | Fe | 0.375 H₂O₂ + 0.25 Fe → 0.25 FeHO₂ + | 0.914 | −0.611 |
| | | 0.25 H₂O | | |
| OH⁻ | Fe_{0.9}O_{0.1} | 0.3571 H₂O₂ + 0.2857 Fe0.9O_{0.1} → 0.2571 | 0.820 | −0.592 |
| | | FeHO₂ + 0.2286 H₂O | | |
| OH⁻ | La_{0.1}Fe_{0.9} | 0.3438 H₂O₂ + 0.3125 La_{0.1}Fe_{0.9} → 0.25 | 0.583 | −0.703 |
| | | FeO + 0.03125 LaFeO₃ + 0.3438 H₂O | | |
| OH⁻ | Ce_{0.1}Fe_{0.9} | 0.3438 H₂O₂ + 0.3125 Ce_{0.1}Fe_{0.9} → | 0.582 | −0.708 |
| | | 0.03125 CeO₂ + 0.2812 FeO + 0.3438 | | |
| | | H₂O | | |
| OH⁻ | Fe_{0.9}Pt_{0.1} | 0.2703 Fe_{0.9}Pt_{0.1} + 0.3649 H₂O₂ → 0.2432 | 0.658 | −0.594 |
| | | FeHO₂ + 0.2432 H₂O + 0.02703 Pt | | |

TABLE 3
CO₃/K reactivity

| | | | | Most stable |
|---|---|---|---|---|
| | | | Most stable | reaction |
| | Material + | | reactant | energy |
| Reactant | dopant | Most stable reaction | ratio [wt.] | [eV/at] |
| CO₃ | Fe | 0.5 CO₃ + 0.5 Fe → 0.5 FeCO₃ | 1.075 | −0.728 |
| K | Fe | No reactions found | 0.000 | 0.000 |
| CO₃ | Fe_{0.9}N_{0.1} | 0.5263 Fe_{0.9}N_{0.1} + 0.4737 CO₃ → | 1.045 | −0.699 |
| | | 0.4737 FeCO₃ + 0.02632 N₂ | | |
| K | Fe_{0.9}N_{0.1} | No reactions found | 0.000 | 0.000 |
| CO₃ | Fe_{0.9}Cl_{0.1} | 0.4643 CO₃ + 0.5357 Fe_{0.9}Cl_{0.1} → | 0.967 | −0.703 |
| | | 0.4643 Fe CO₃ + 0.01786 FeCl₃ | | |
| K | Fe_{0.9}Cl_{0.1} | 0.09091 K + 0.9091 Fe_{0.9}Cl_{0.1} → 0.8182 | 0.073 | −0.257 |
| | | Fe + 0.09091 KCl | | |
| CO₃ | Fe_{0.9}Br_{0.1} | 0.4595 CO₃ + 0.5405 Fe_{0.9}Br_{0.1} → | 0.876 | −0.703 |
| | | 0.02703 FeBr₂ + 0.4595 FeCO₃ | | |
| K | Fe_{0.9}Br_{0.1} | 0.09091 K + 0.9091 Fe_{0.9}Br_{0.1} → 0.8182 | 0.067 | −0.260 |
| | | Fe + 0.09091 KBr | | |
| CO₃ | Fe_{0.9}Pt_{0.1} | 0.5263 Fe_{0.9}Pt_{0.1} + 0.4737 CO₃ → | 0.774 | −0.702 |
| | | 0.4737 FeCO₃ + 0.05263 Pt | | |
| K | Fe_{0.9}Pt_{0.1} | No reactions found | 0.000 | 0.000 |

Halogens were found to be easily reduced for K and CO₃ and to form salts with K.

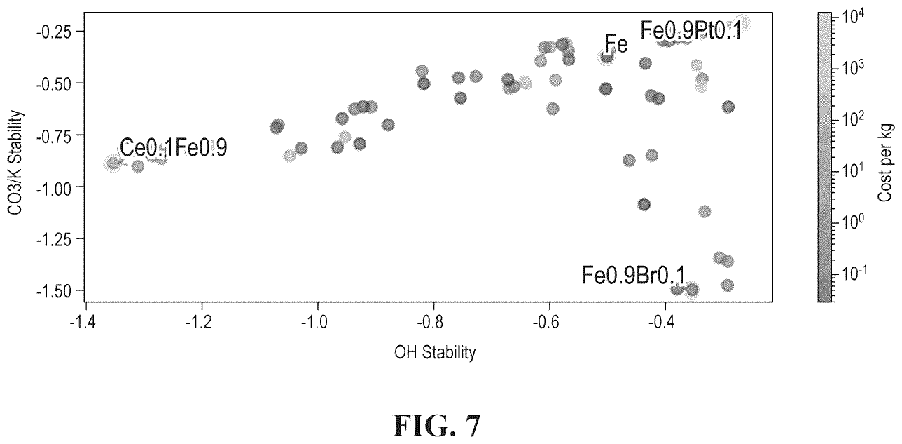

An overall plot of stability against CO₃/K, OH− in relation to material cost was constructed by combining the derived data according to the methods described above. 76 materials were screened. The stability-cost results for the Fe-based materials is shown in FIG. 7 and Table 4 (top 5 candidates). In the plot of FIG. 7, the cost is indicated as depth of color with darker shades indicating a less expensive material and lighter colors indicating a more expensive material (that is true for all scatter plots showing cost in this disclosure). As can be seen from the plot of FIG. 7, Ce's resistance to OH− is not suitable, Br is unstable against CO₃/K, and Pt is nonreactive. Cost may be a prohibitive factor for some compounds having good resistance towards CO₃/K and OH− such as precious metals.

TABLE 4
OH, CO₃, K stability, and cost considerations

| Material + | | | |
|---|---|---|---|
| dopant | OH stability | CO₃/K stability | Cost per kg |
| Fe_{0.9}Pt_{0.1} | −0.267 | −0.214 | 13808.381 |
| Fe_{0.9}Ir_{0.1} | −0.323 | −0.253 | 11618.989 |
| Fe_{0.9}Au_{0.1} | −0.337 | −0.520 | 12778.736 |
| Fe_{0.9}Os_{0.1} | −0.338 | −0.264 | 3972.718 |
| Fe_{0.9}Pd_{0.1} | −0.341 | −0.261 | 4025.298 |

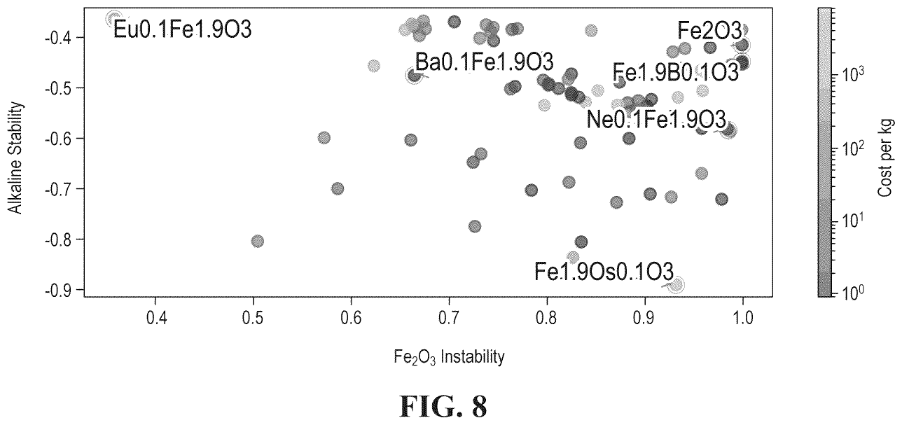

Oxide materials were further tested for stability with Fe₂O₃ structure. In the oxidized state, La was identified as a very good candidate, along with carbon, chromium (i.e. stainless steel), and aluminum. Results of the screening of 81 materials may be seen in the scatterplot of FIG. 8 and in Table 5.

TABLE 5
Top oxide candidate elements for steel enhancement

| Material + | Fe₂O₃ structural | | |
|---|---|---|---|
| dopant | stability | Alkaline stability | Cost per kg |
| La_{0.1}Fe_{1.9}O₃ | 1.000 | −0.387 | 29.823 |
| Fe₂O₃ | 1.000 | −0.417 | 0.922 |
| B_{0.1}Fe_{1.9}O₃ | 1.000 | −0.450 | 0.954 |
| C_{0.1}Fe_{1.9}O₃ | 1.000 | −0.455 | 1.133 |
| Be_{0.1}Fe_{1.9}O₃ | 0.989 | −0.456 | 3.554 |
| Al_{0.1}Fe_{1.9}O₃ | 0.967 | −0.422 | 0.981 |
| Rh_{0.1}Fe_{1.9}O₃ | 0.960 | −0.507 | 1248.71 |
| Ru_{0.1}Fe_{1.9}O₃ | 0.959 | −0.671 | 93.899 |
| Pd_{0.1} Fe_{1.9}O₃ | 0.958 | −0.467 | 1488.939 |
| Cr_{0.1}Fe_{1.9}O₃ | 0.952 | −0.390 | 1.011 |

### III. Binary and Ternary Oxides Search Based on Chemical Reactivity

Binary and ternary metal oxides with 20-80% molar content of oxygen were searched to identify elements suitable for steel enhancement in the conditions representative of an AEM electrolyzer anode (pH=13 and V=0.6). The search omitted elements that are reactive or unsuitable such as radioactive elements: F, Cl, Hg, He, H, Li, As, Se, Br, Cd, I, Sb, Te, Pr, Sm, Eu, Gd, Tb, Dy, Ho, Er, Tm, Yb, and Lu.

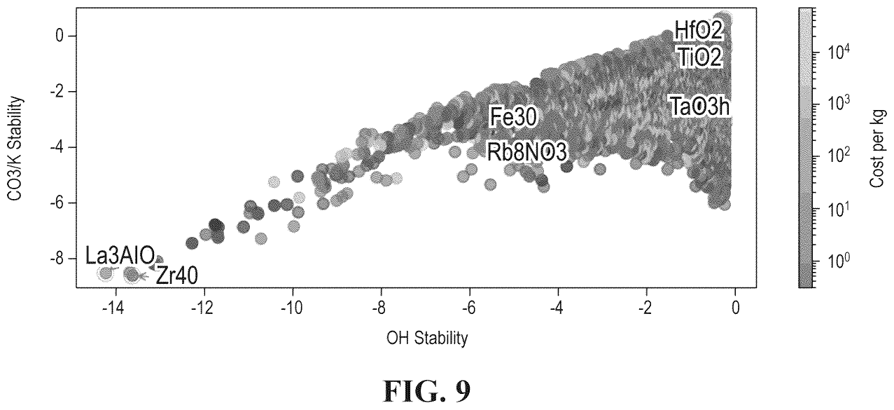

OH⁻ and CO₃/K stability was explored as above. 13756 materials were searched; the search scatterplot is shown in FIG. 9. TiO₂ emerged as a strong candidate. Suboxides were identified as reactive. The top candidates with cost <$20/kg elemental cost are listed in Table 6 below.

TABLE 6
Top candidate binary and ternary oxides

| Material | OH stability | CO₃/K stability | Cost per kg |
|---|---|---|---|
| MgCr₂O₄ | −0.250 | 0.611 | 3.075 |
| ZrO₂ | −0.250 | 0.529 | 2.741 |
| MgAl₂O₄ | −0.250 | 0.414 | 3.13 |
| Mg₇Al₂₂O₄₀ | −0.337 | 0.319 | 3.009 |
| MgZr₄O₉ | −0.302 | 0.313 | 2.85 |
| Mg₂Cr₂O₅ | −0.322 | 0.301 | 3.267 |
| Ca₃Zr₁₇O₃₇ | −0.281 | 0.289 | 2.858 |
| Mg₃Al₁₄O₂₄ | −0.380 | 0.269 | 2.927 |
| BeAl₆O₁₀ | −0.399 | 0.264 | 14.855 |
| Sr₂Zr₇O₁₆ | −0.461 | 0.248 | 2.49 |

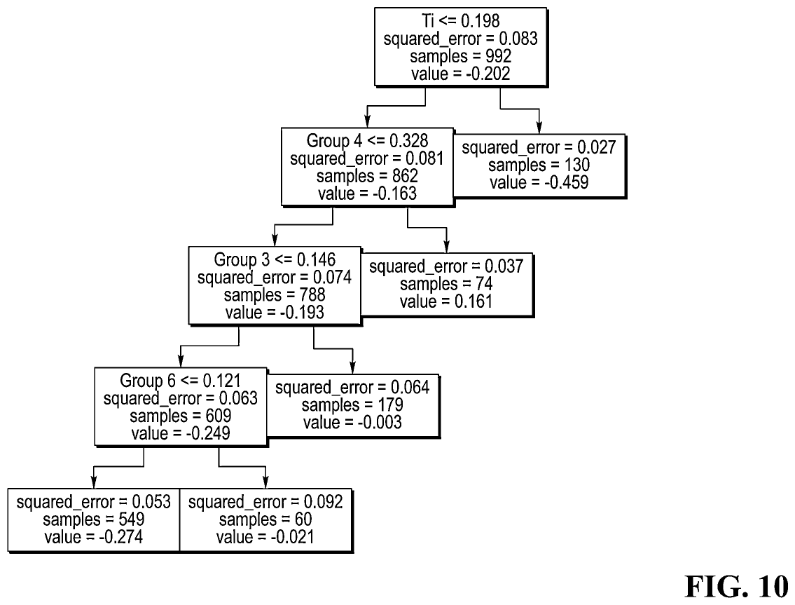

Additionally, a decision tree analysis was performed. The features are elemental molar fraction and chemical group molar fraction, and a decision tree was trained to find design rules. The focus was on the top 1000 materials only. In the decision tree shown in FIG. 10, the “value” is the sum of the OH stability and CO₃/K stability, the “samples” is the number of materials in that leaf, and “X<=Y” describes the molar fraction of an element or chemical group. A high value (dark grey) is desired, while a low value (white) is undesired, corresponding to a high and low stability, respectively. As can be seen in the decision tree of FIG. 10, a high Ti content (>20% molar or so) has 130 materials that are relatively unstable, whereas a high “Group 4” (Ti, Hf, Zr) of more than 32% molar has 74 samples that have relatively high stability. Group 3 (Sc, Y, La) and Group 6 (Cr, Mo, W) also tend to be better than average.

### IV. Inorganic Compositions Search Based on Chemical Reactivity

An internal database of inorganic materials was used to find the most suitable materials to identify elements suitable for steel enhancement in the conditions representative of an AEM electrolyzer anode (pH=13 and V=0.6). The same OH and CO₃/K stability metrics as above were used, with the caveat that each material has a range of chemical compositions that may be available from a supplier. Multiple compositions were thus sampled and error bars for the materials were included.

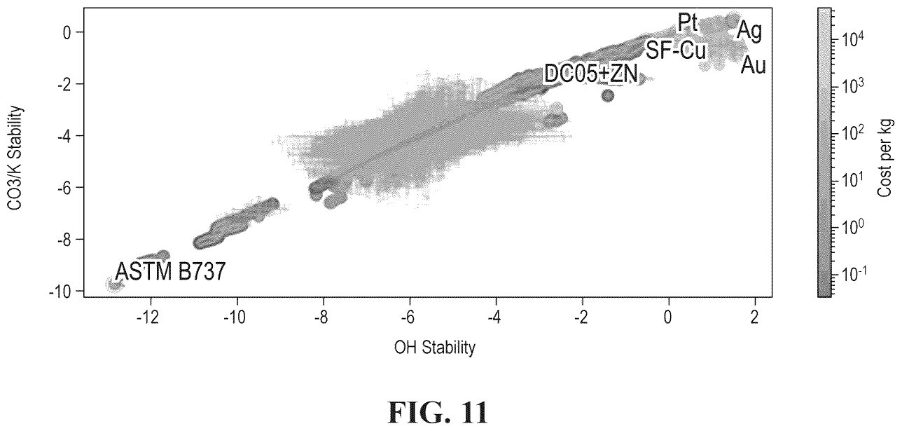

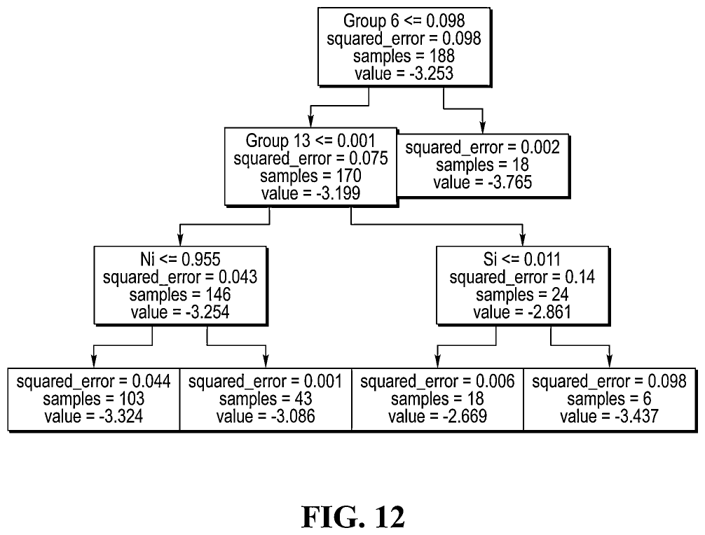

7942 materials were searched, the search is shown in FIG. 11. In the scatterplot of FIG. 11, the desirable placement is in the top right corner. As can be seen in FIG. 11, copper is robustly stable in the search. If the desirable material is to have no more than 50% copper and be cheaper than pure Ni (from elemental cost), 222 materials remain. The 222 materials were further studied via a trained decision tree shown in FIG. 12. Group 6 (Cr, Mo, W) is worse than average in this group, whereas Group 13 (B, Al, Ga, In, Tl) with low Si is better than average. This includes a variety of Ni—Cu alloys as well as other materials. The top candidates are shown in Table 7 below.

TABLE 7
Top candidate inorganic compounds

| Description | OC stability | CO₃/K stability | Cost per kg |
|---|---|---|---|
| Ni—Cu alloy | −1.297772 | −1.188213 | 17.668994 |
| Ni—Cu alloy | −1.312925 | −1.194981 | 18.270913 |
| Ni—Cu alloy | −1.343287 | −1.209439 | 17.600297 |
| Ni—Cu alloy | −1.349423 | −1.223930 | 18.540949 |

### V. Steel Search Based on Chemical Reactivity

Materials from search IV., described above, were further screened for steel materials including Fe.

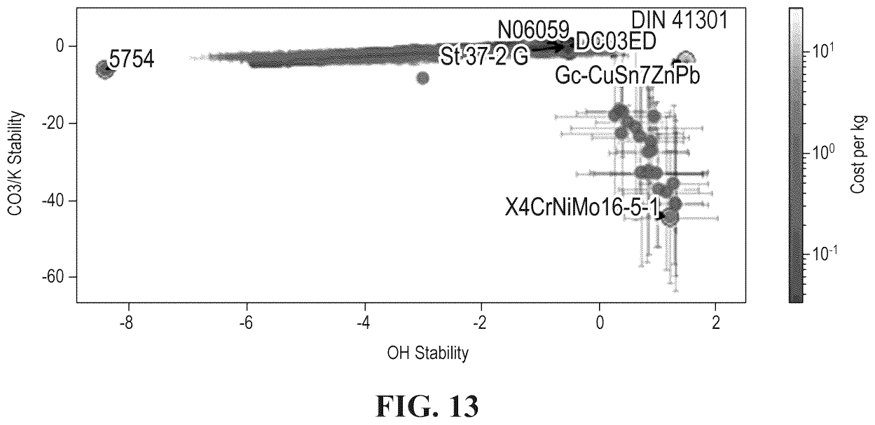

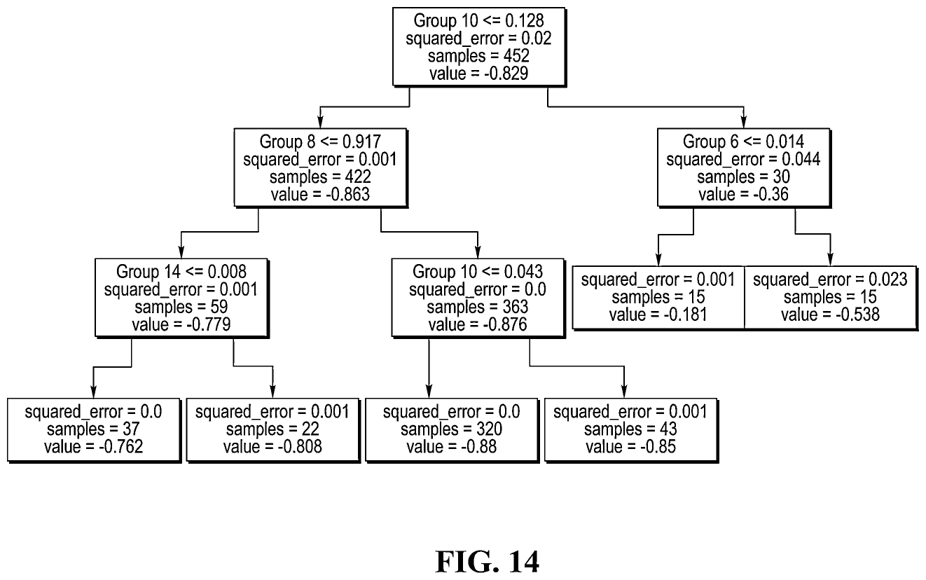

4930 materials were screened, as can be seen in FIG. 13. The decision tree analysis, shown in FIG. 14, was performed with the top 450 materials to identify the chemistries that are most beneficial for the conditions representative of an AEM electrolyzer anode (pH=13 and V=0.6). Group 10 (Ni, Pd, Pt) performed better than average. Group 6 (Cr, Mo, W) are markers of decreased stability, which may want to be avoided in the AEM electrolyzer application.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An alkaline electrochemical cell component comprising:
a bulk portion; and
a surface portion including a conductive, electrochemically and chemically stable material having one or more compounds of formula (I):
La(Ni₁₋ₓCuₓ)O₃ (I),
where 0<=x<=1,
the electrochemical cell having a pH>7.

2. The cell component of claim 1, wherein the component is a bipolar plate, gas diffusion layer, or porous transport layer.

3. The cell component of claim 1, wherein the one or more surface compounds include LaNiO₃, LaCuO₃, or both.

4. The cell component of claim 1, further comprising one or more compounds of formula (III), different from the one or more compounds of formula (I):
AₓB_{y}O_{z}, (III),
where
A is La or an alkaline earth metal,
B is a transition or post-transition metal,
x is any number between 0 and 7,
y is any number between 0.1 and 22, and
z is any number between 1 and 40.

5. The cell component of claim 1, wherein the surface portion includes one or more portions free of the material of formula (I).

6. The cell component of claim 1, wherein the bulk portion includes steel.

7. The cell component of claim 1, wherein the electrochemical cell is an alkaline exchange membrane electrolyzer.

8. The cell component of claim 1, wherein at least some of the one or more surface compounds of formula (I) include one or more oxygen vacancies.

9. An alkaline electrochemical cell comprising:
one or more surfaces having a conductive, electrochemically and chemically stable material having one or more compounds of formula (I):
La(Ni₁₋ₓCuₓ)O₃ (I),
where 0<=x<=1,
the electrochemical cell having a pH>7.

10. The cell of claim 9, wherein the electrochemical cell is an alkaline exchange membrane electrolyzer.

11. The cell of claim 9, wherein the one or more surface compounds include LaNiO₃, LaCuO₃, or both.

12. The cell of claim 9, wherein the conductive, electrochemically and chemically stable material further includes one or more compounds of formula (III), different from the one or more compounds of formula (I):
AₓB_{y}O_{z} (III),
where
A is La or an alkaline earth metal,
B is a transition or post-transition metal,
x is any number between 0 and 7,
y is any number between 0.1 and 22, and
z is any number between 1 and 40.

13. The cell of claim 11, wherein at least some of the one or more surface compounds of formula (I) include one or more oxygen vacancies.

14. The cell of claim 9, wherein the conductive, electrochemically and chemically stable material has electrical conductivity of at least 10⁻¹ S/cm.

15. A conductive, electrochemically and chemically stable material comprising:
a first oxide having a formula (I):
La(Ni₁₋ₓCuₓ)O₃ (I),
where 0<=x<=1; and
a second oxide having formula (III), different from the one or more compounds of formula (I):
AₓB_{y}O_{z} (III),
where
A is La or an alkaline earth metal,
B is a transition or post-transition metal,
x is any number between 0 and 7,
y is any number between 0.1 and 22, and
z is any number between 1 and 40.
the material is an alkaline corrosion resistant material having electrical conductivity of at least 10⁻¹ S/cm.

16. The material of claim 14, wherein the first oxide includes oxygen vacancies.

17. The material of claim 14, wherein the first oxide includes LaNiO₃, LaCuO₃, or both.

18. The material of claim 14, wherein B includes Cr, Zr, Al, or Ti.

19. The material of claim 14, wherein the second oxide includes magnesium.

20. The material of claim 14 further comprising a third oxide having formula (V):
A_{0.1}Fe_{1.9}O₃ (V),
where A is La, B, C, Be, Al, Rh, Ru, Pd, or Cr.
